(19) United States
(12) Patent Application Publication
(10) Pub. No.: US 2017/0317548 A1
(43) Pub. Date: Nov. 2, 2017

(54) ELECTRIC POWER TOOL

(71) Applicant: MAKITA CORPORATION, Anjo-shi (JP)

(72) Inventors: Ryosuke SUZUKI, Anjo-shi (JP); Akira NIWA, Anjo-shi (JP)

(73) Assignee: MAKITA CORPORATION, Anjo-shi (JP)

(21) Appl. No.: 15/485,765

(22) Filed: Apr. 12, 2017

(30) Foreign Application Priority Data
Apr. 28, 2016 (JP) 2016-091246
Feb. 9, 2017 (JP) 2017-022416

(51) Int. Cl. H02K 3/34; B23D 47/12; B23D 45/16; H02K 1/14; H02K 11/30

(52) U.S. Cl. CPC H02K 3/34; H02K 1/146; H02K 11/30; B23D 45/16; B23D 47/12

(57) ABSTRACT

An electric power tool is configured to drive a tool bit. The electric power tool includes a motor that includes a stator and a rotor. The stator includes a cylindrical stator core that includes an inner peripheral side with a slot, a first insulator and a second insulator installed on respective both end surfaces of the stator core, and a coil wound around the slot of the stator core via the first insulator and the second insulator. The rotor is rotatable with respect to the stator. The rotor includes a rotor core and a rotation shaft. The first insulator overlaps with the second insulator in the slot in an axial direction of the stator core.

### BACKGROUND

This application claims the benefit of Japanese Patent Application Numbers 2016-091246 filed on Apr. 28, 2016 and 2047-022416 filed on Feb. 9, 2017, the entirety of which is incorporated by reference.

### TECHNICAL FIELD

The disclosure relates to an electric power tool that employs a wire-wound type motor.

### RELATED ART

As an electric power tool such as an impact driver, there has been known an electric power tool that employs a motor such as a brushless motor as a driving source. For example, Japanese Patent Application Publication No. 2008-54391 discloses an electric power tool that employs a brushless motor. The brushless motor includes a stator, in which a plurality of coils are wound around a stator core via a resin-made insulator (insulating member), and a rotor with a rotation shaft. To the stator, a sensor circuit board that includes a rotation detecting element for detecting a position of a permanent magnet disposed on the rotor to output a rotation detection signal is secured.

In such wire-wound type motor, it is necessary to ensure an insulation distance between the coil wound around the stator core and the stator core.

Therefore, it is an object of the disclosure to provide an electric power tool that ensures an insulation distance between a coil and a stator core.

### SUMMARY

In order to achieve the above-described object, there is provided an electric power tool configured to drive a tool bit according to an aspect of the disclosure. The electric power tool may include a motor that includes a stator and a rotor. The stator may include a cylindrical stator core that includes an inner peripheral side with a slot, a first insulator and a second insulator installed on respective both end surfaces of the stator core, and a coil wound around the slot of the stator core via the first insulator and the second insulator. The rotor may be rotatable with respect to the stator, and the rotor may include a rotor core and a rotation shaft. The first insulator may overlap with the second insulator in the slot in an axial direction of the stator core.

It is preferable that the first insulator and the second insulator each may include a fitting rib configured to fit to the slot, and end portions of the fitting ribs may overlap with one another.

It is preferable that one fitting rib may be formed in a tapered shape toward the other fitting rib side, and the one fitting rib may have an end portion that overlaps with an end portion of the other fitting rib from inside.

It is preferable that the fitting rib on the second insulator side may be formed longer than the fitting rib on the first insulator side in the axial direction of the stator core.

It is preferable that the fitting rib of the second insulator may have an outer peripheral base portion that includes a groove whose bottom portion has a cross-sectional shape in a semicircular shape.

It is preferable that the fitting rib on the second insulator side may have a semi-cylindrical shape that opens an inner peripheral side corresponding to an opening side of the slot, and both edges on the inner peripheral side each may include folded portions so as to be folded back to an outer peripheral side and subsequently extended to a center side.

There is provided an electric power tool configured to drive a tool bit according to another aspect of the disclosure. The electric power tool may include a motor that includes a stator and a rotor. The stator may include a cylindrical stator core that includes a slot on an inner peripheral side, a first insulator and a second insulator installed on respective both end surfaces of the stator core, and a coil wound around the slot of the stator core via the first insulator and the second insulator. The rotor may be rotatable with respect to the stator, and the rotor may include a rotor core and a rotation shaft. The first insulator and the second insulator may engage with one another to be secured to the stator core.

It is preferable that the first insulator and the second insulator each may include a fitting rib configured to fit to the slot, and end portions of the fitting ribs may engage with one another.

It is preferable that the end portions of the fitting ribs may engage with one another by inserting one fitting rib into a gap between the other fitting rib and an inner surface of the slot.

There is provided an electric power tool configured to drive a tool bit according to another aspect of the disclosure. The electric power tool may include a motor that includes a stator and a rotor. The stator may include a cylindrical stator core that includes a slot on an inner peripheral side, and an insulator that includes a fitting portion disposed to protrude on a ring portion installed on an end surface of the stator core, and the fitting portion may fit to the slot. The rotor may be rotatable with respect to the stator, and the rotor may include a rotor core and a rotation shaft. A groove may be depressed along an outer periphery of the protruding part of the fitting portion on the ring portion.

It is preferable that the groove may have a bottom portion whose lateral cross-sectional shape is a semicircular shape.

There is provided an electric power tool configured to drive a tool bit according to another aspect of the disclosure. The electric power tool may include a motor that includes a stator and a rotor. The stator may include a cylindrical stator core that includes a slot on an inner peripheral side, a first insulator and a second insulator installed on respective both end surfaces of the stator core, and a coil wound around the slot of the stator core via the first insulator and the second insulator. The rotor may be rotatable with respect to the stator, and the rotor may include a rotor core and a rotation shaft. A first insulation paper may be interposed between the stator core and the coil in the slot, and a second insulation paper may be disposed integrally with or independent of the first insulation paper on a center side of the stator core with respect to the coil, and the second insulation paper may overlap with the first insulation paper in a radial direction of the stator core.

It is preferable that the first insulator and the second insulator each may include a fitting rib configured to fit to the slot, and may be disposed in a state where the first insulation paper and the second insulation paper respectively overlap with an inner side of the fitting rib and an outer side of the fitting rib in the radial direction.

It is preferable that the second insulation paper may be disposed across a plurality of teeth adjacent in the circumferential direction, the teeth may be disposed to protrude from the stator core to the center side.

It is preferable that a gap may be disposed between the fitting rib and the tooth such that the second insulation paper is inserted into the gap.

It is preferable that the first insulation paper may have a semi-cylindrical shape configured to fit to the slot with a shape approximately identical to an inner shape of the slot.

According to the disclosure, an insulation distance between a coil and a stator core is ensured. In this case, an AC motor to which a greater electric power is add provides a greater efficiency.

### BRIEF DESCRIPTION OF THE DRAWINGS

FIG. 1 is a perspective view of a circular saw.

FIG. 2 is a right side view of the circular saw.

FIG. 3 is a plan view of the circular saw.

FIG. 4 is a front view of the circular saw,

FIG. 5 is a cross-sectional view taken along the line A-A of FIG. 3.

FIGS. 6A and 6B are explanatory drawings of a stator, and FIG. 6A is a perspective view from front and FIG. 6B is a perspective view from rear.

FIGS. 7A to 7C are explanatory drawings of the stator, and FIG. 7A is a front view, FIG. 7B is a side view, and FIG. 7C is a rear view.

FIG. 8 is an exploded perspective view of the stator.

FIGS. 9A and 9B are explanatory drawings of a rear insulator, and FIG. 9A is a perspective view from front and FIG. 9B is a perspective view from rear.

FIGS. 10A to 10C are explanatory drawings of the rear insulator, and FIG. 10A is a front view, FIG. 10B is a side view, and FIG. 10C is a rear view.

FIGS. 11A and 11B are explanatory drawings of a front insulator, and FIG. 11A is a perspective view from front and FIG. 11B is a perspective view from rear.

FIGS. 12A to 12C are explanatory drawings of the front insulator, and FIG. 12A is a front view, FIG. 12B is a side view, and FIG. 12C is a rear view.

FIGS. 13A to 13C are explanatory drawings of a stator core on which the front and rear insulators are assembled, and FIG. 13A is a rear view, FIG. 13B is a cross-sectional view taken along the line A-A of FIG. 13A, and FIG. 13C is a cross-sectional view taken along the line B-B of FIG. 13A.

FIG. 14A is an enlarged view of a part C of FIG. 13B.

FIG. 14B is an enlarged view of a part D of FIG. 13B.

FIGS. 15A to 15C are explanatory drawings of the stator core on which the front and rear insulators are assembled and a coil is wound around, and FIG. 15A is a rear view, FIG. 15B is a cross-sectional view taken along the line A-A of FIG. 15A, and FIG. 15C is a cross-sectional view taken along the line B-B of FIG. 15A.

FIG. 16A is an enlarged cross-sectional view taken along the line E-E of FIG. 15B.

FIG. 16B is an enlarged view of a part G of FIG. 16A.

FIG. 17A is an enlarged cross-sectional view taken along the line F-F of FIG. 15B.

FIG. 17B is an enlarged view of a part H of FIG. 17A.

FIGS. 18A and 18B are explanatory drawings of a stator core where a length of a fitting rib is changed, and FIG. 18A is a rear view and FIG. 18B is a cross-sectional view taken along the line I-I of FIG. 18A.

FIGS. 19A and 19B are explanatory drawings of the stator core where the length of the fitting rib is changed, and FIG. 19A is a rear view and FIG. 19B is a cross-sectional view taken along the line J-J of FIG. 19A.

FIGS. 20A to 20C are explanatory drawings of a stator that employs an insulation paper, and FIG. 20A is a perspective view from rear, FIG. 20B is a rear view, and FIG. 20C is a front view.

FIG. 21A is a lateral cross-sectional view of the stator core.

FIG. 21B is an enlarged view of a part K of FIG. 21A.

FIGS. 22A to 22C are explanatory drawings of a stator where the coil is omitted, and FIG. 22A is a perspective view from rear, FIG. 22B is a rear view, and FIG. 22C is a front view.

FIG. 23A is a center vertical cross-sectional view of the stator of FIGS. 22A to 22C.

FIG. 23B is an enlarged view a part L of FIG. 23A.

FIG. 24 is an exploded perspective view of the insulation paper with respect to the stator.

FIGS. 25A to 25C are explanatory drawings of the stator where the coil and the insulation paper are omitted, and FIG. 25A is an enlarged perspective view of a slot portion, FIG. 25B is a rear view, and FIG. 25C is a front view.

### DETAILED DESCRIPTION

The following describes embodiments of the disclosure based on the drawings.

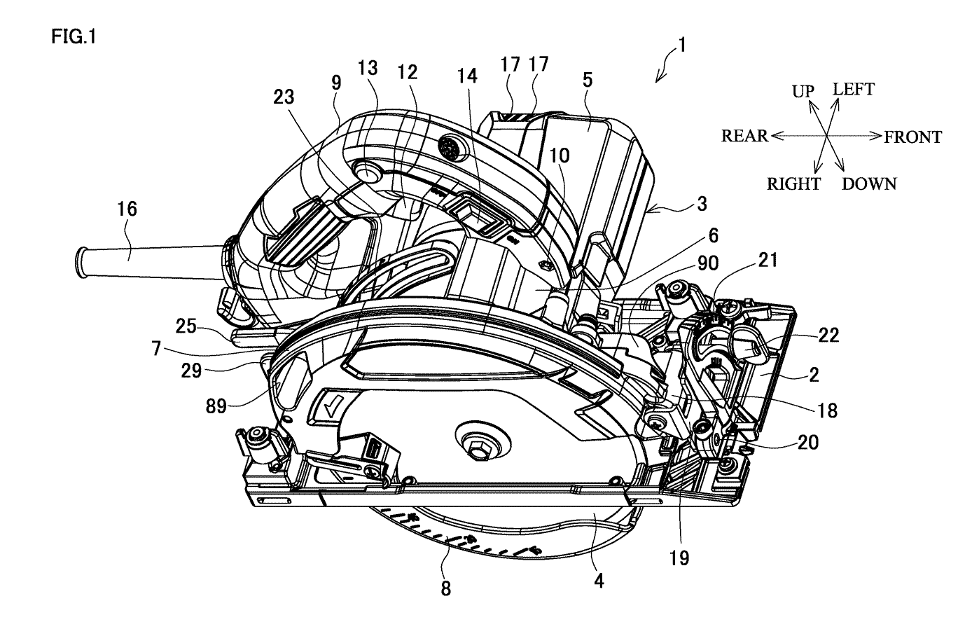

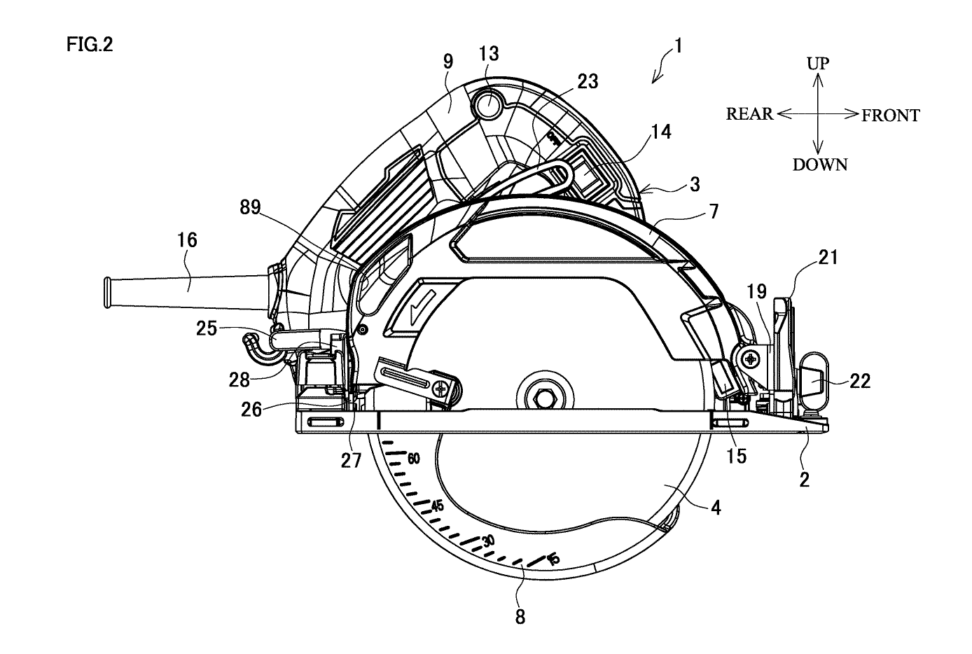

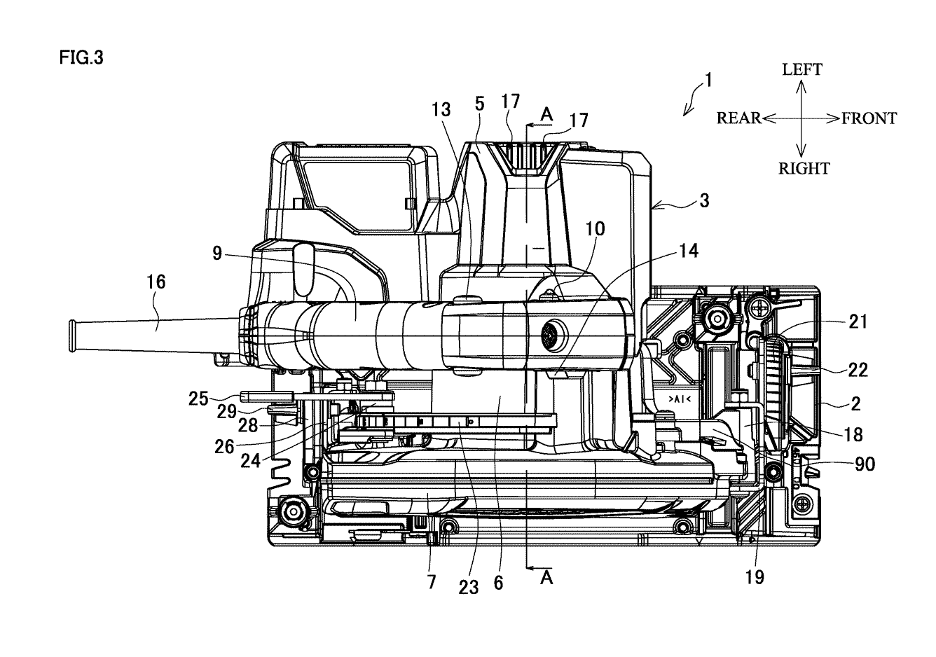

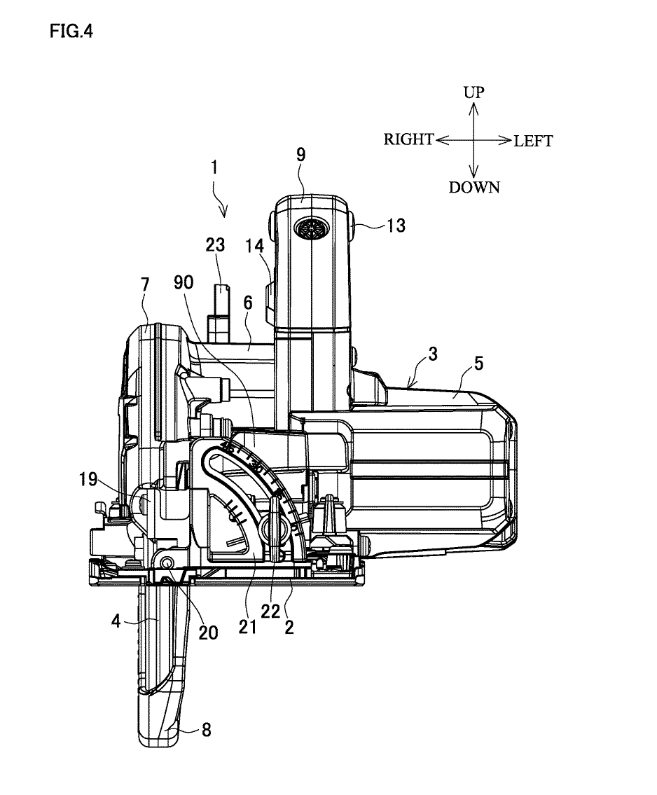

FIG. 1 is a perspective view of a circular saw as an exemplary electric power tool, FIG. 2 is a right side view, FIG. 3 is a plan view, and FIG. 4 is a front view.

A circular saw 1 is constituted of a base 2 that has a rectangular shape in a plan view and a main body 3 that includes a disc-shaped saw blade 4 as a tool bit rotatably driven by a brushless motor 30 (described later), such that the main body 3 is set on the base 2. The main body 3 includes a motor housing 5, which houses the brushless motor 30, on a left side, a gear housing 6, which houses a gear portion for transmitting rotation of the brushless motor 30 to the saw blade 4, coupled to a right side of the motor housing 5, and a blade case 7, which covers an upper half of the saw blade 4, on a right side of the gear housing 6. The saw blade 4 has a lower portion that passes through the base 2 to project downward, and is covered with a safety cover 8 that is installed on the blade case 7 and rotationally biased to a position indicated in FIGS. 1 and 2 in an ordinary state.

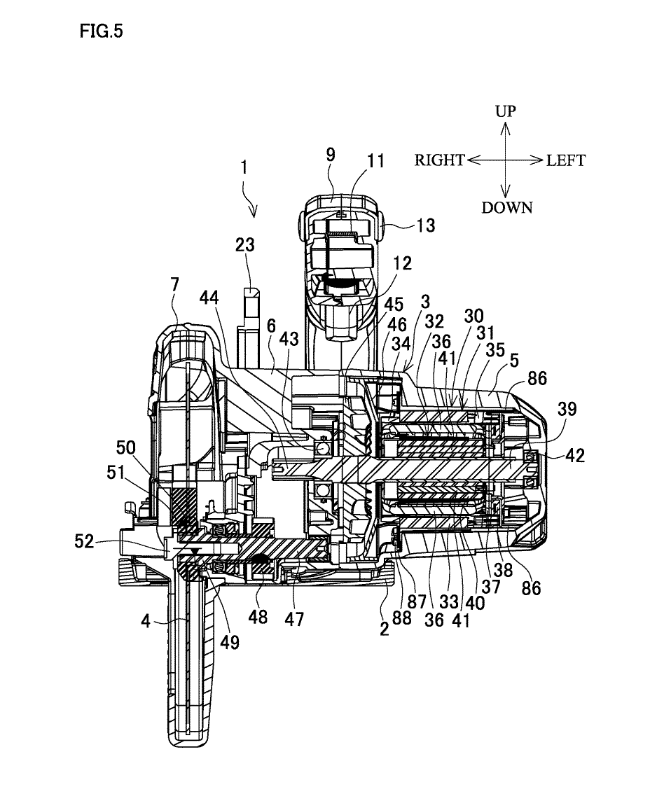

On the upper side of the motor housing 5 and the gear housing 6, a loop-shaped handle 9 is disposed in a front-rear direction. The handle 9 is formed of right and left half parts consecutively installed on respective motor housing 5 and gear housing 6 by fastening with screws 10, 10 . . . from a left side. The handle 9 houses a switch 11 (FIG. 5) that includes a trigger 12 projecting inside, and includes a lock-on button 13, which holds a push-in position of the trigger 12, on the upper side of the switch 11. The handle 9 has a front right side on which a light switch 14 is disposed, and a rear end to which a power supply cord 16 is coupled. The light switch 14 turns on a light (not illustrated) disposed on a front portion of the blade case 7 to irradiate a cut position via a lens 15. The motor housing 5 has a left end surface on which air intake openings 17, 17 . . . are disposed.

Furthermore, the blade case 7 has a front portion to which a front support plate 19, which has a U shape in a plan view, is coupled by a spindle 18 in a right-left direction. The front support plate 19 is coupled on the base 2 so as to be tiltable in the right-left direction by a shaft 20 in the front-rear direction. On the front side of the front support plate 19, a front guide portion 21, which has an arc-shaped slit around the shaft 20 as the center, is disposed upright on the base 2, and a hand screw 22 passing through the slit of the front guide portion 21 is screwed on the front support plate 19.

On the other hand, on the left side of the rear portion of the blade case 7, an arc-shaped depth guide 23 is disposed, and on the rear portion of the blade case 7, a clamp shaft 24, which passes through the depth guide 23 and includes a depth adjustment lever 25 on a distal end, is disposed. On the lower end of the depth guide 23 and the rear of the blade case 7, a rear support plate 26 is disposed to extend to be coupled to the base 2 by a shaft 27 that is coaxial with the shaft 20. The rear support plate 26 is tiltable in the right-left direction. On the rear side of the rear support plate 26, a rear guiding portion 28, which includes an arc-shaped slit around the shaft 27 as the center, is disposed upright on the base 2, and a hand screw 29 passing through the slit of the rear guiding portion 28 is screwed on the rear support plate 26.

In the above configuration, when the front and rear hand screws 22 and 29 are loosened, the main body 3 is allowed to be tilted in the right-left direction in a movable range in the slit of the front and rear guiding portions 21 and 28, thus adjusting an inclination angle of the saw blade 4 with respect to the base 2.

When the depth adjustment lever 25 is operated to loosen the clamp shaft 24, the main body 3 is allowed to be rotated in an up-down direction around the spindle 18 as the center, thus adjusting a projection amount (cutting amount) of the saw blade 4 from the base 2.

FIG. 5 is a cross-sectional view taken along the line A-A of FIG. 3. The motor housing 5 houses the brushless motor 30 and a controller (not illustrated) that includes a control circuit board ahead of the brushless motor 30. The following describes an internal structure of the motor housing 5 and the gear housing 6. However, a description of this internal structure will be given with a left side of FIG. 5 as a front.

The brushless motor 30 is an inner rotor type motor constituted of a stator 31 and a rotor 32 inside the stator 31.

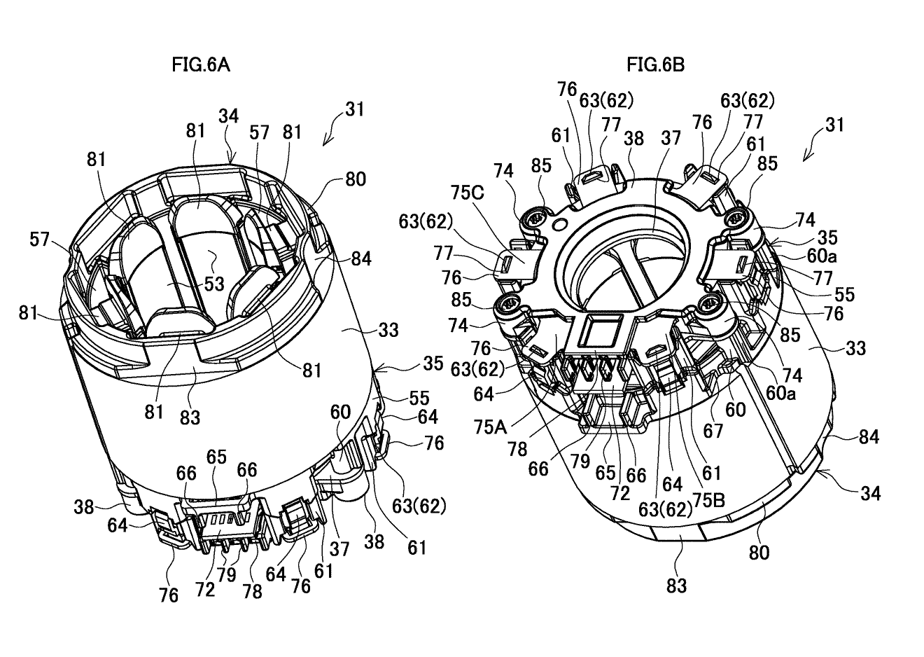

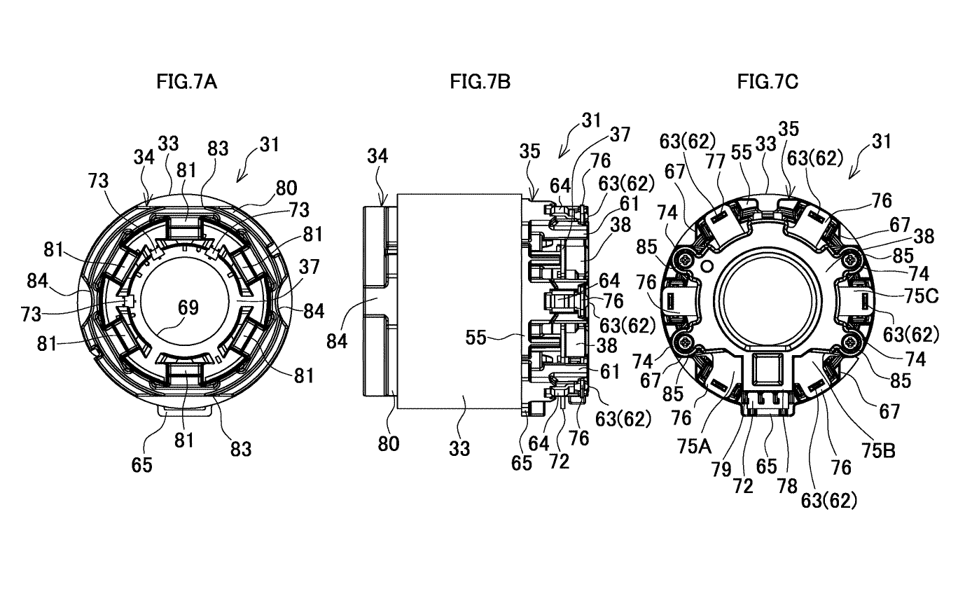

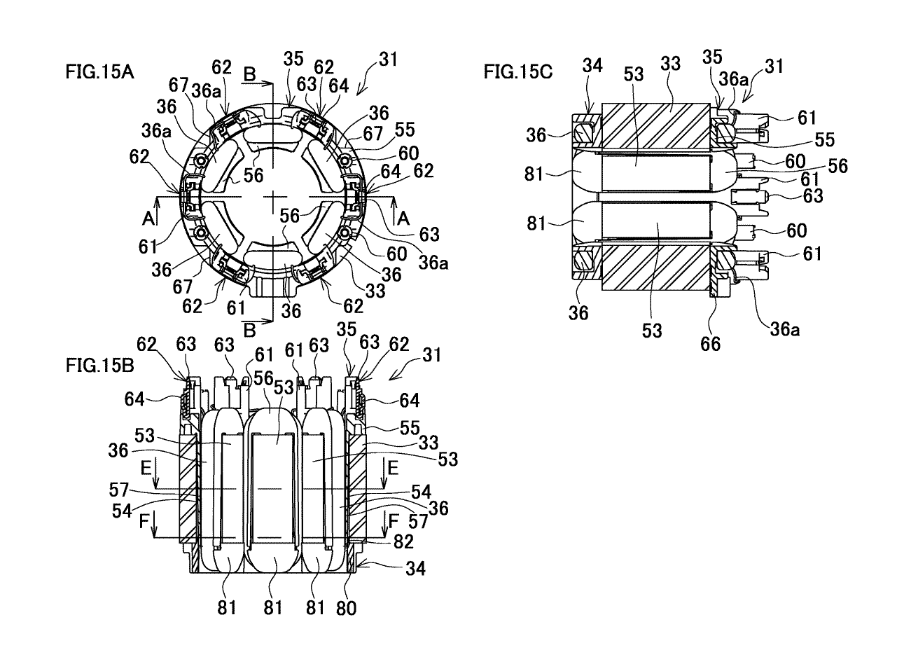

First, as also illustrated in FIG. 6A to FIG. 7C, the stator 31 includes a stator core 33, a front insulator 34 and a rear insulator 35, and coils 36, 36 . . . (FIG. 5, and FIGS. 15A to 15C). The stator core 33 is formed of a plurality of laminated steel plates and has a tubular shape. The front insulator 34 and the rear insulator 35 are respectively disposed on front and rear end surfaces of the stator core 33 in the axial direction as a first insulator and a second insulator. The coils 36, 36 . . . are wound around the stator core 33 via the front and rear insulators 34 and 35, and disposed on each of a U-phase, a V-phase, and a W-phase by a pair, thus six coils 36, 36 . . . are disposed in total. The rear insulator 35 includes a sensor circuit board 37 and a short-circuit member 38. The stator 31 will be described later in detail.

On the other hand, the rotor 32 includes a rotation shaft 39 lying on an axial center, an approximately cylindrical rotor core 40 disposed on a peripheral area of the rotation shaft 39 and formed of a plurality of laminated steel plates, and four plate-shaped permanent magnets 41, 41 . . . secured to the inside of the rotor core 40.

The rotation shaft 39 has a rear end pivotally supported by a bearing 42 held onto an inner surface of a rear portion of the motor housing 5, and a front end pivotally supported by a bearing 43 held onto a rear portion of the gear housing 6. A pinion 44 disposed on a distal end of the rotation shaft 39 projects into the gear housing 6. The rotation shaft 39 includes a centrifugal fan 45 on the rear of the bearing 43. On the front end of the motor housing 5 that houses the centrifugal fan 45, a baffle plate 46 is disposed to guide airflow generated from the centrifugal fan 45 in a radiation direction forward. The airflow from the centrifugal fan 45 is delivered into the blade case 7 via a through hole (not illustrated) passing through the gear housing 6 from front to back.

In the gear housing 6, an intermediate shaft (not illustrated), which includes a gear engaging with the pinion 44 of the rotation shaft 39, is pivotally supported on the lower side of the front side of the rotation shaft 39 and is parallel to the rotation shaft 39. Further, in the gear housing 6, a spindle 47, which includes a gear 48 engaging with the gear of the intermediate shaft, is pivotally supported on the lower side of the front side of the intermediate shaft and is parallel to the intermediate shaft. The spindle 47 has a distal end projecting into the blade case 7. The saw blade 4 is fastened to the spindle 47 by a bolt 52 in a state where the saw blade 4 is sandwiched between an inner flange 50, which is externally installed to the spindle 47 on a position abutting to a receiving flange 49 disposed on the spindle 47, and an outer flange 51, which is externally installed outside the inner flange 50, and the spindle 47 passes through the saw blade 4.

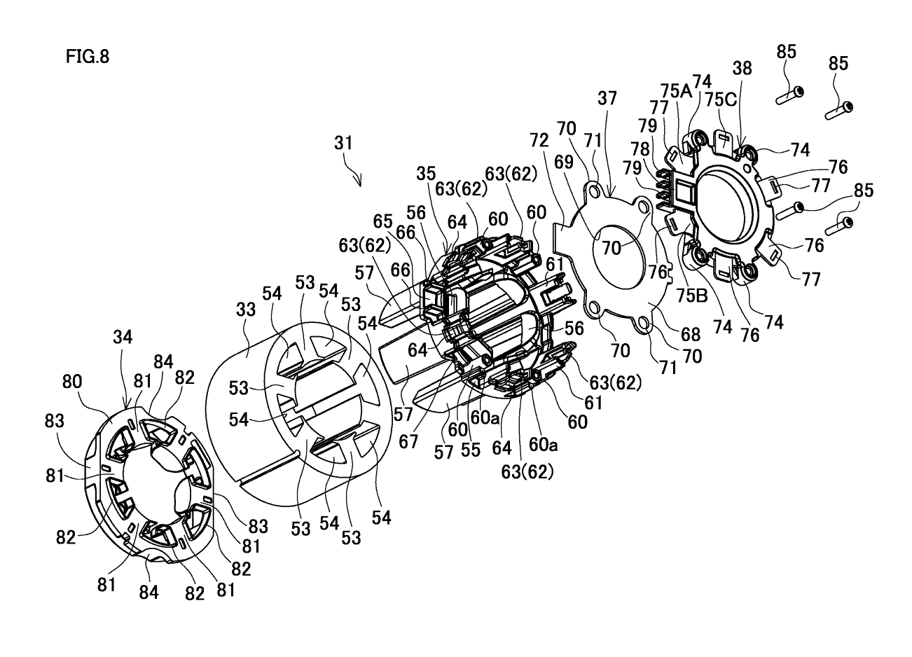

Next, a description will be given of a structure of the stator 31 in detail. First, as illustrated in FIG. 8, on the inner periphery of the stator core 33, six teeth 53, 53 . . . , which each have a T-shape in the front view, are disposed to protrude toward an axial center side at equal intervals, and six slots 54, 54 . . . are disposed between the respective teeth 53, 53 . . . .

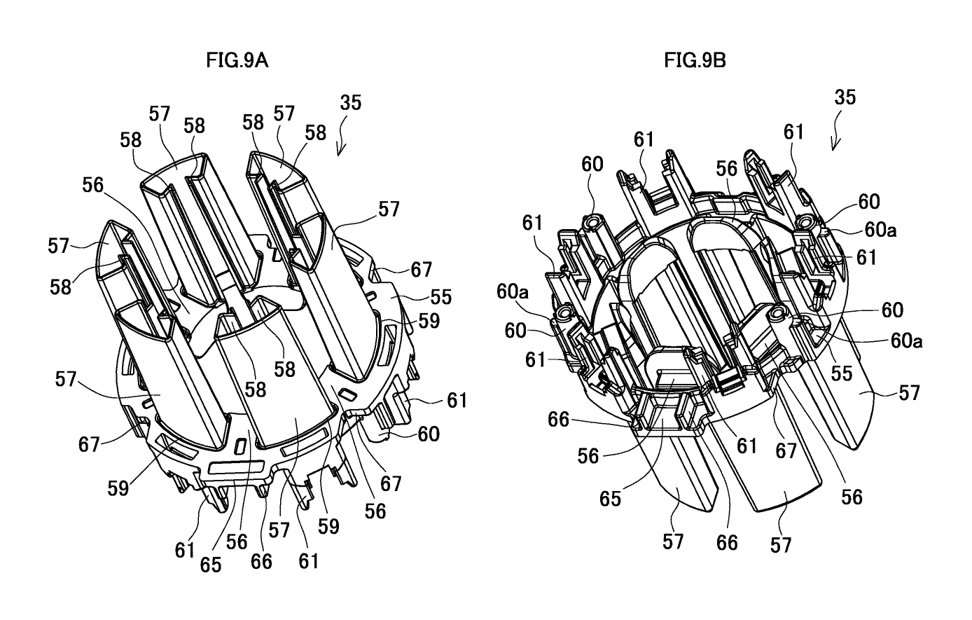

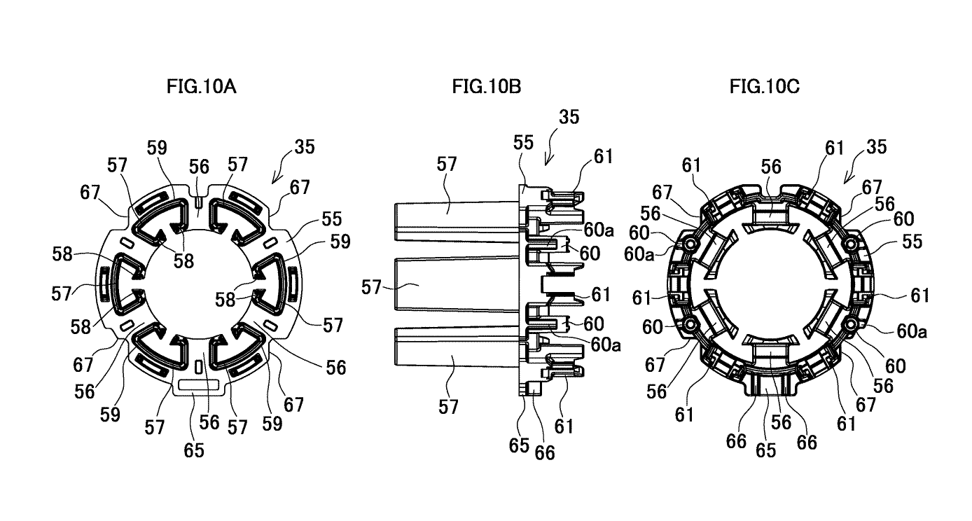

As illustrated in FIG. 9A to FIG. 10C, the rear insulator 35 is integrally molded of a resin-made ring portion 55 and six insulation ribs 56, 56 . . . . The ring portion 55 has an outer diameter approximately identical to a diameter of the stator core 33. The six insulation ribs 56, 56 . . . have a T-shape in the rear view, and are disposed on the inner peripheral side of the ring portion 55 in the radial direction and located on the rear surfaces of the respective teeth 53. On the front surface of the rear insulator 35, six rear fitting ribs 57, 57 . . . are disposed over the inner edges of the insulation ribs 56, 56 adjacent to one another in the circumferential direction and the inner edge of the ring portion 55. Each of the rear fitting ribs 57, 57 . . . has a shape approximately identical to the inner shape of the slot 54 and is served as a fitting portion that fits to each slot 54.

The rear fitting ribs 57 pass through the respective slots 54 in a state where the rear insulator 35 is assembled to the stator core 33, have a length slightly exceeding the front end surface of the stator core 33, and have a semi-cylindrical shape opening the inner peripheral side corresponding to the opening side of the slot 54. The rear fitting ribs 57 each have a tapered shape such that an outer shape gradually decreases from the base toward front. The respective rear fitting ribs 57 have both edges on the inner peripheral side on which folded portions 58, 58 are each formed such that the folded portion 58 is obliquely folded back to the outer peripheral side and subsequently extends to the center side in the radial direction.

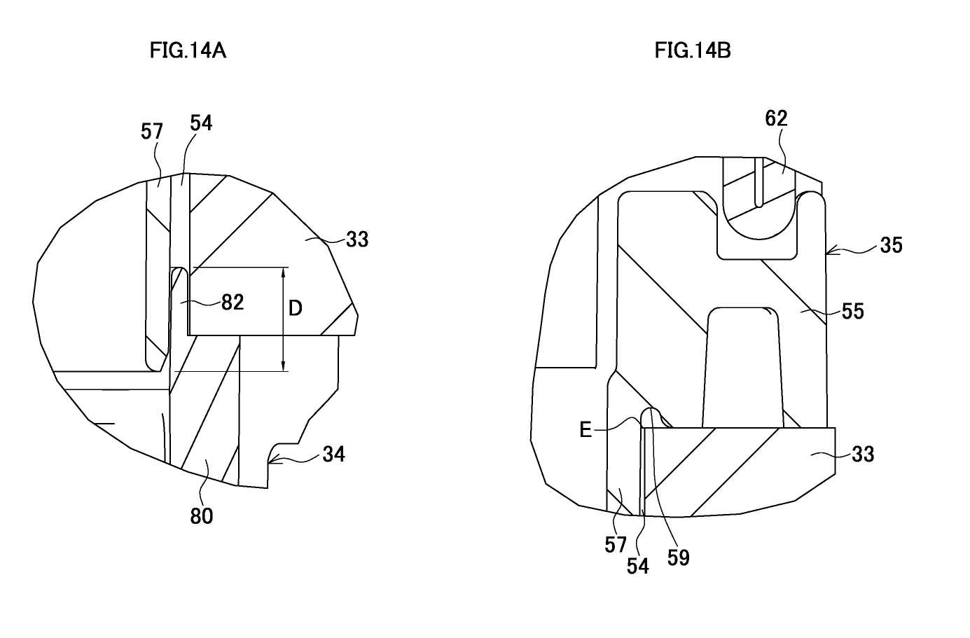

On the front surface of the rear insulator 35, a groove 59 (FIG. 14B), whose bottom portion has a cross-sectional shape in a semicircular shape, is depressed over the whole circumference of the base portion of the outer periphery of each of the rear fitting ribs 57.

Furthermore, on the rear surface of the ring portion 55, four screw bosses 60, 60 . . . are disposed to protrude to screw the sensor circuit board 37 such that the screw bosses 60, 60 . . . are located on respective vertexes of a rectangle. Receiving portions 60a are continuously installed on the outer sides of the respective screw bosses 60 lower with respect to the screw boss 60, so as to receive the sensor circuit board 37. Between the respective screw bosses 60, 60, six holding portions 61, 61 . . . are disposed upright on a concentric circle at equal intervals, and the holding portions 61, 61 . . . hold respective fusing terminals 62, 62 . . . (FIG. 6B and FIG. 7C). The fusing terminal 62 is formed by folding a strip-shaped metal plate in half such that the folded side is the distal end, one end side as a base portion 63 is put on the inner side to be inserted into the holding portion 61, and the other end side as a clamping piece 64 holds a crossover wire between the coils 36, 36 from outside. On the outer periphery of the ring portion 55, extension pieces 65, on which ribs 66, 66 are disposed upright on right and left, are disposed to protrude in the radiation direction, and a plurality of cutout portions 67, 67 . . . are disposed.

The sensor circuit board 37 has an outer diameter that is slightly small compared with the inner diameter of the ring portion 55 of the rear insulator 35, and includes a circular plate portion 68 that has an open hole 69 on the center, four fixing pieces 70, 70 . . . that each has a penetration hole 71 configured such that the four screw bosses 60, 60 . . . pass through, and a connecting piece 72 disposed on the rear of the extension piece 65 of the ring portion 55. The fixing pieces 70 and the connecting piece 72 are radially disposed to protrude on the outer periphery of the circular plate portion 68. On the front surface of the circular plate portion 68, rotation detecting elements 73, 73 . . . (FIG. 7A) are disposed to detect a position of the permanent magnet 41 disposed on the rotor 32. Six signal lines electrically coupled to the rotation detecting elements 73 are pulled out from the connecting piece 72.

The short-circuit member 38 is made of resin, has a ring shape, and has a diameter approximately identical to the sensor circuit board 37. The short-circuit member 38 has the outer periphery on which four screw-hole bosses 74, 74 . . . are integrally disposed to protrude. The screw-hole bosses 74, 74 . . . correspond to the screw bosses 60, 60 . . . disposed on the rear insulator 35. The short-circuit member 38 is formed by an insert molding in a state where three arc-shaped sheet metal members 75A, 75B, and 75C . . . , which each include a pair of short-circuit pieces 76, 76 projecting on a diagonal line, are overlapped on the concentric circle without contacting one another. The short-circuit pieces 76 radially project from the short-circuit member 38 to correspond to the respective fusing terminals 62, and each have the distal end on which a slit 77 is disposed to be configured such that the base portion 63 of the fusing terminal 62 is inserted. On the respective sheet metal members 75A to 75C, power lines of three phases are each welded and pulled out from a pull-out portion 78 disposed on a rear position of the connecting piece 72 of the sensor circuit board 37 on the outer periphery of the short-circuit member 38. A partition rib 79 is disposed upright on the pull-out portion 78 to partition the power lines.

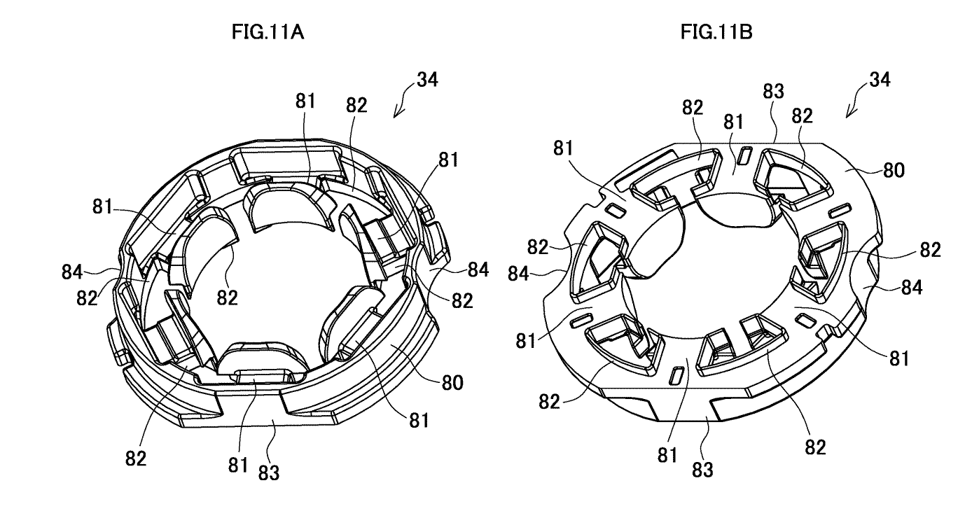

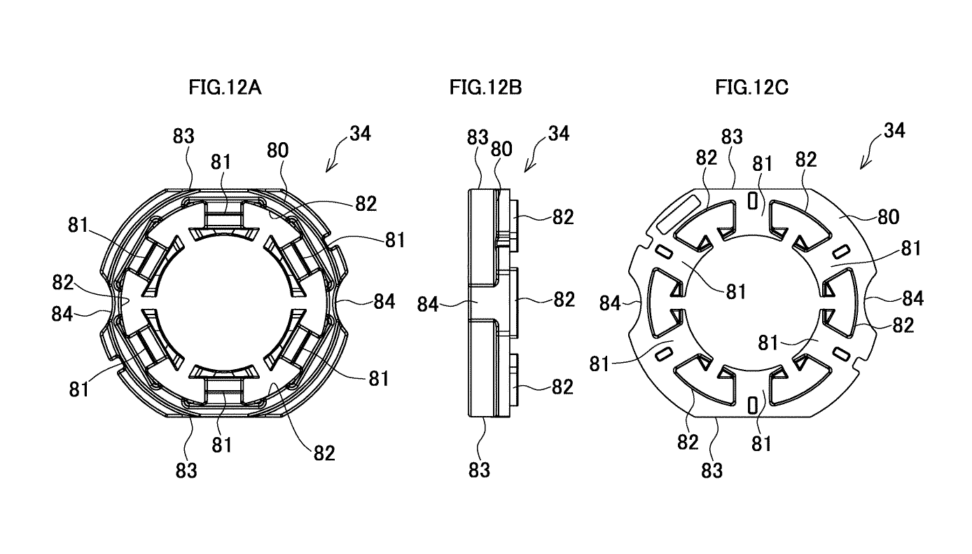

As illustrated in FIG. 11A to FIG. 12C, the front insulator 34 is also integrally molded of a resin-made ring portion 80 and six insulation ribs 81, 81 . . . . The ring portion 80 has an outer diameter approximately identical to a diameter of the stator core 33. The six insulation ribs 81, 81 . . . are disposed on the inner peripheral side of the ring portion 80 in the radial direction and located on the front surfaces of the respective teeth 53 of the stator core 33. On the rear surface of the front insulator 34, similar to the rear insulator 35, semi-cylindrical front fitting ribs 82, 82 . . . , which project rearward to fit to the respective slots 54, are disposed to protrude over the inner edges of the insulation ribs 81, 81 adjacent to one another in the circumferential direction and the inner edge of the ring portion 80. However, the front fitting rib 82 has a projection length shorter than the projection length of the rear fitting rib 57. On the outer periphery of the ring portion 80, a pair of chamfering portions 83, 83 is disposed on a point symmetry position, and a pair of depressed portions 84, 84 is disposed on a point symmetry position in a different phase.

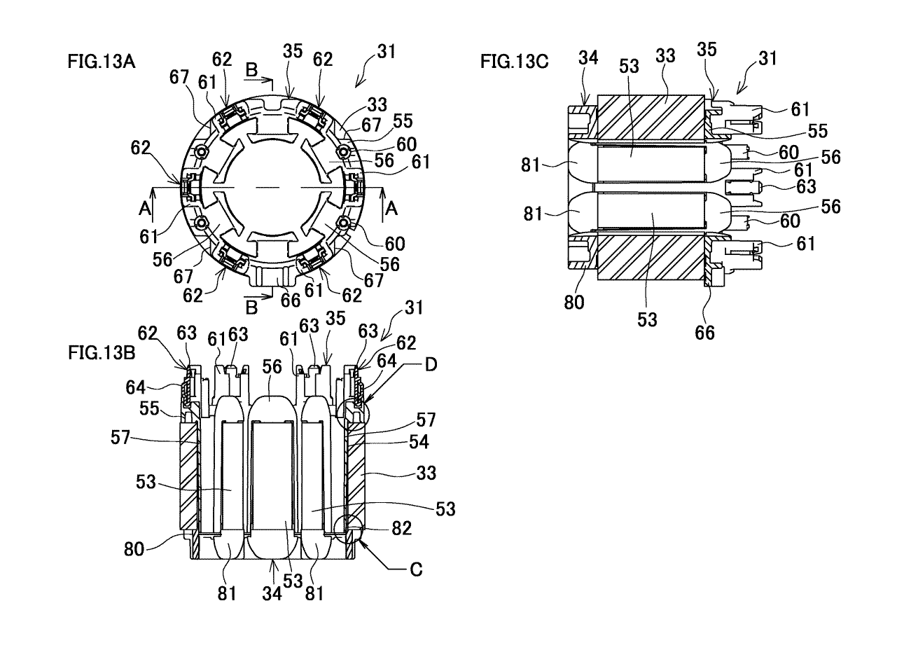

Therefore, in the stator 31, the front insulator 34 and the rear insulator 35 are inserted from the front and the rear of the stator core 33 until the ring portions 55 and 80 each contact the end surface of the stator core 33 in the identical phase in a state where the front fitting ribs 82 and the rear fitting ribs 57 are fit to the respective slots 54. Then, as illustrated in FIG. 13A to FIG. 14A, the end portion of the tapered-shaped rear fitting rib 57 overlaps (overlapping), from inside, with the front fitting rib 82 that fits to the slot 54, on the front end of the stator core 33. Thus, the inner surfaces of the respective slots 54 are covered with both fitting ribs 57 and 82.

The overlapping part (part D in FIG. 14A) of the ring portion 80 and the rear fitting rib 57 is 2.4 mm in the axial direction of the stator 31. This exceeds 2 mm as a minimum value of the insulation distance (spatial distance and creepage distance) specified by “Ministerial Ordinance for Determining Technical Standards for Electrical Appliances” Paragraph 1, Appended Table 8, and is a sufficient distance for ensuring insulation.

The above-mentioned assembling is preferably performed as described below. First, the front insulator 34 is assembled such that the front insulator 34 is put lower and the stator core 33 is fitted from above, and similar way. Then, the rear insulator 35 is fitted such that the rear insulator 35 is inserted from upward of the stator core 33, and similar way. This is because the rear fitting rib 57 of the rear insulator 35 is inserted into the inside of the front fitting rib 82 in a state where the front fitting rib 82 fits to the slot 54 to firmly secure the front insulator 34 to the stator core 33 without rattling, thus making the front fitting rib 82 be smoothly inserted so as to provide an easy assembling.

As described above, in a state where both insulators 34 and 35 are assembled, since the front fitting rib 82 is inserted into a gap between the rear fitting rib 57 and the inner surface of the slot 54 to engage both fitting ribs 57 and 82 with one another. Therefore, a resistance is generated in exiting directions of both fitting ribs 57 and 82, and both insulators 34 and 35 are secured to the stator core 33.

In the state where the rear insulator 35 is secured, as illustrated in FIG. 14B, while an edge E of the inner periphery of the slot 54 is close to the base of the rear fitting rib 57 on the rear end surface of the stator core 33, the groove 59 is disposed along the outer periphery of each rear fitting rib 57 on the base. Therefore, the edge E is prevented from interfering with the rear fitting rib 57. Since the groove 59 has a lateral cross-sectional surface of the bottom portion in the semicircular shape, the fluidity of the resin is ensured, and the possibility of generating a molding defect of the rear fitting rib 57 is decreased even when the groove 59 is disposed.

Then, in the stator core 33 where the front and rear insulators 34 and 35 are assembled, the fusing terminals 62 are each inserted into each of the holding portions 61 of the rear insulator 35. Subsequently, as illustrated in FIG. 15A to FIG. 15C, the coils 36, 36 . . . are wound around the respective teeth 53 in an order in the circumferential direction such that a crossover wire 36a passes between the base portion 63 and the clamping piece 64 of each fusing terminal 62. Thus, the crossover wire 36a is fused at each fusing terminal 62. In the above configuration, the six coils 36 are continuously wound around by one wire. On one fusing terminal 62, a starting end and a terminating end of the wire are fused.

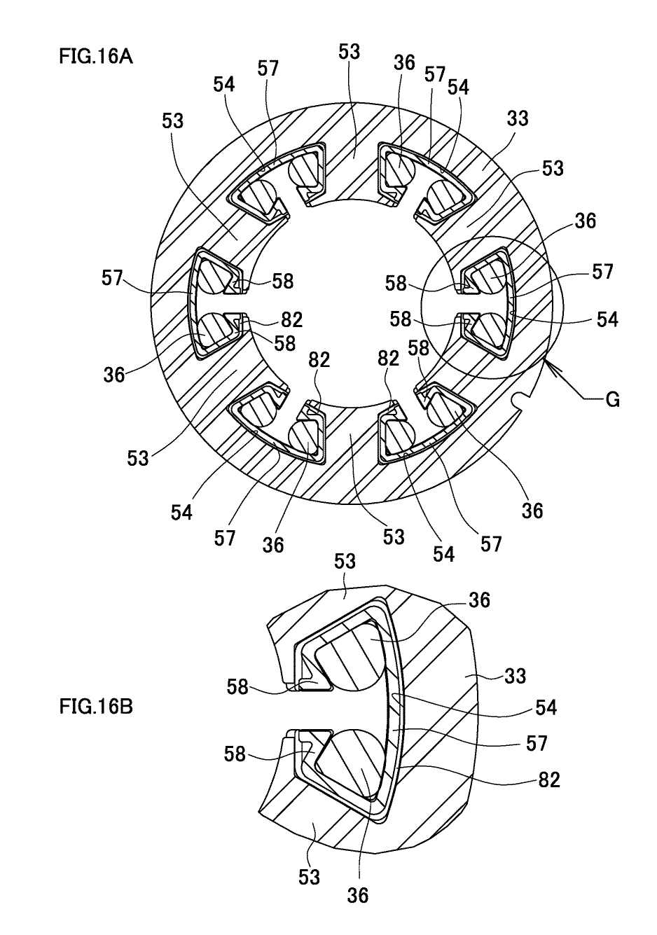

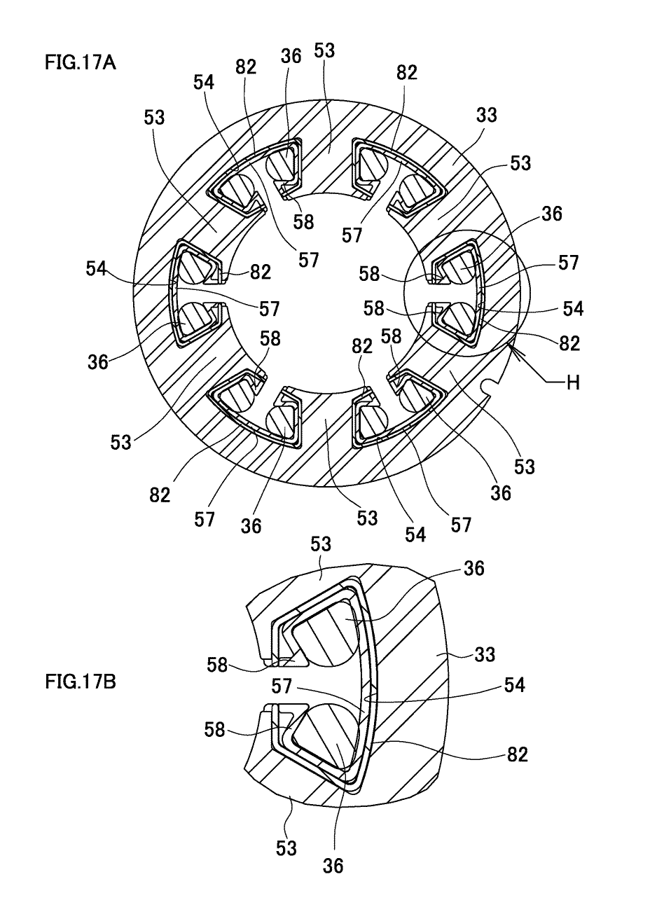

In the state where the coils 36 are wound around, as illustrated in FIG. 16A and FIG. 16B, the rear fitting rib 57 is interposed between the coil 36 passing through the slot 54 and the teeth 53 in a range from the rear end to the front portion of the stator core 33 in the axial direction, thus ensuring the insulation distance between the coil 36 and the stator core 33. Further, on the front end of the stator core 33, as illustrated in FIGS. 15A to 15C and FIGS. 17A and 17B, since the rear fitting rib 57 and the front fitting rib 82 overlapping with one another are interposed between the coil 36 and the teeth 53, the insulation distance between the coil 36 and the stator core 33 is ensured. In the state where the coils 36 are wound around, the folded portions 58, 58 on the inner peripheral side of the rear fitting rib 57 restrict the coil 36 to move to the center side, thus ensuring the insulation distance with the distal end side of the teeth 53. Instead of the folded portion 58, the insulation distance is also ensured by gradually increasing the thickness of the end portion as approaching the center side of the slot 54. In this case again, the insulation distance can be ensured with not an insulation paper but the resin. However, the thick end portion possibly generates such as a warping due to a molding shrinkage, thus the folded portion 58 has an advantage in formability.

Then, the sensor circuit board 37 is set on the receiving portion 60a while the screw bosses 60 of the rear insulator 35 are inserted into the respective penetration holes 71 of the fixing pieces 70. The short-circuit member 38 is put from the rear of the sensor circuit board 37 so as to cause the respective screw bosses 60 to fit to the respective screw-hole bosses 74, thus fixing the short-circuit member 38 with screws 85, 85 . . . . Then, as illustrated in FIG. 6A to FIG. 7C, the base portions 63 of the fusing terminals 62 are each inserted into the corresponding short-circuit piece 76. When the base portion 63 and the short-circuit piece 76 are soldered in this state, the fusing terminals 62, 62 arranged point symmetrically are short-circuited by the respective sheet metal members 75A to 75C. That is, in a state where the pairs of the coils 36, 36 in the respective phases are each disposed diagonally, the fusing terminals 62, 62 . . . , electrically coupled to the crossover wires 36a between the coils 36, 36, are each electrically coupled to the diagonally located fusing terminal 62 by the three sheet metal members 75A to 75C, thus it is what is called a delta connection of a parallel winding.

In the above embodiment, the sensor circuit board 37 and the short-circuit member 38 are disposed within the height dimension of the fusing terminal 62, thus reducing the whole length of the stator 31 to minimum even such as the short-circuit member 38 is used. Furthermore, since every member other than the signal line and the power line is put in the outer diameter of the stator core 33, the product is made compact without increasing the outer diameter. The signal line and the power line are each horizontally pulled out from the connecting piece 72 and the pull-out portion 78 that overlap back and forth, thus making the wiring easy. However, the signal line and the power line may be pulled out from the upper or the lower, or may be pulled out from the positions different from one another.

As illustrated in FIG. 5, the stator 31 configured as described above is positioned in the motor housing 5 in a state where a positioning portion 86 disposed to protrude on the inner surface of the motor housing 5 is in contact with the rear surface of the stator core 33 by fitting to the cutout portion 67 disposed on the ring portion 55 of the rear insulator 35. In this state, an installation plate 87, which engages with the front insulator 34 on the positions of the chamfering portions 83 and the depressed portions 84 disposed on the outer periphery of the ring portion 80, is screwed to the motor housing 5 with a screw 88 while the installation plate 87 is abutted on the front surface of the stator core 33, so that the stator 31 is fixed.

According to the circular saw 1 configured as described above, when the trigger 12 is pushed to turn on the switch 11, the brushless motor 30 is supplied with power via the controller, so as to rotate the rotation shaft 39. That is, the control circuit board of the controller obtains the rotation detection signal, which is output from the rotation detecting element 73 of the sensor circuit board 37 and indicates the position of the permanent magnet 41 of the rotor 32, to obtain the rotating state of the rotor 32. Then, the control circuit board of the controller controls ON/OFF of the respective switching elements included on the control circuit board corresponding to the obtained rotating state, and provides current to the respective coils 36 of the stator 31 subsequently, thus rotating the rotor 32 with the rotation shaft 39. Then, the spindle 47 is decelerated to rotate via the intermediate shaft engaging with the pinion 44, and the saw blade 4 is rotated in an arrow direction indicated on the side surface of the blade case 7 in FIG. 2, thus allowing a workpiece to be cut.

Then, when the centrifugal fan 45 rotates in accordance with the rotation of the rotation shaft 39, the air taken in from the air intake opening 17 of the motor housing 5 passes the brushless motor 30 to cool, subsequently passes the inside of the gear housing 6 via the baffle plate 46, and is discharged into the blade case 7. In the blade case 7, the air joins with an airflow generated by the rotation of the saw blade 4 to blow cutting dust rearward, so as to be discharged from a discharge port 89 disposed on the rear right side surface of the blade case 7.

The gear housing 6 has a front portion on which a duct 90 (FIGS. 1 and 3) is disposed to guide air flowing forward from the baffle plate 46 to the front end of the blade case 7 to discharge the air downward. The air ejected from the duct 90 blows off the cutting dust on the workpiece, so as to cause such as an ink line to be easy to see.

Thus, according to the circular saw 1 configured as described above, the front insulator 34 overlaps with the rear insulator 35 in the slot 54 in the axial direction of the stator core 33. The above configuration insulates between the coil 36 and the stator core 33 in the assembly state of the front and rear insulators 34 and 35 without using such as the insulation paper. Therefore, the insulation distance between the coil 36 and the stator core 33 is ensured with a simple configuration including a small number of components. Even there is a variation in a stack tolerance of the laminated steel plate in the stator core 33, the overlapping part can absorb the variation, thus ensuring the insulation distance.

Especially, in this embodiment, the front insulator 34 and the rear insulator 35 respectively include the front fitting rib 82 and the rear fitting rib 57, which fit to the slot 54, and the end portions of both fitting ribs 82 and 57 overlap with one another, thus surely insulating between the coil 36 and the stator core 33.

Since the front insulator 34 and the rear insulator 35 are engaged with one another so as to be secured to the stator core 33, the insulation distance between the coil 36 and the stator core 33 is ensured and both insulators 34 and 35 are easily assembled.

Especially, in this embodiment, since the end portions of the front and rear fitting ribs 82 and 57 are engaged with one another, both fitting ribs 82 and 57 are used to fix both insulators 34 and 35 without rattling.

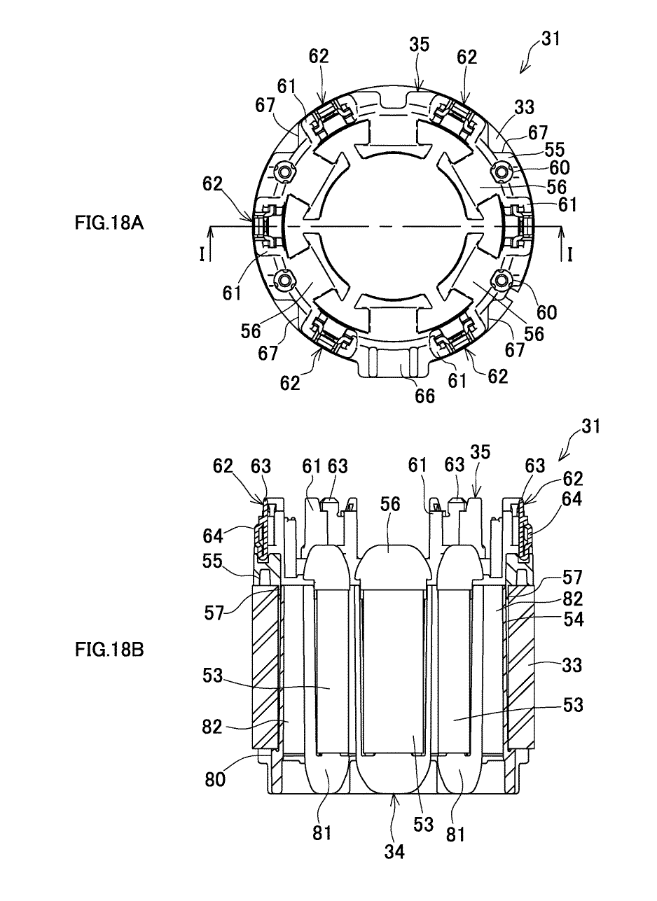

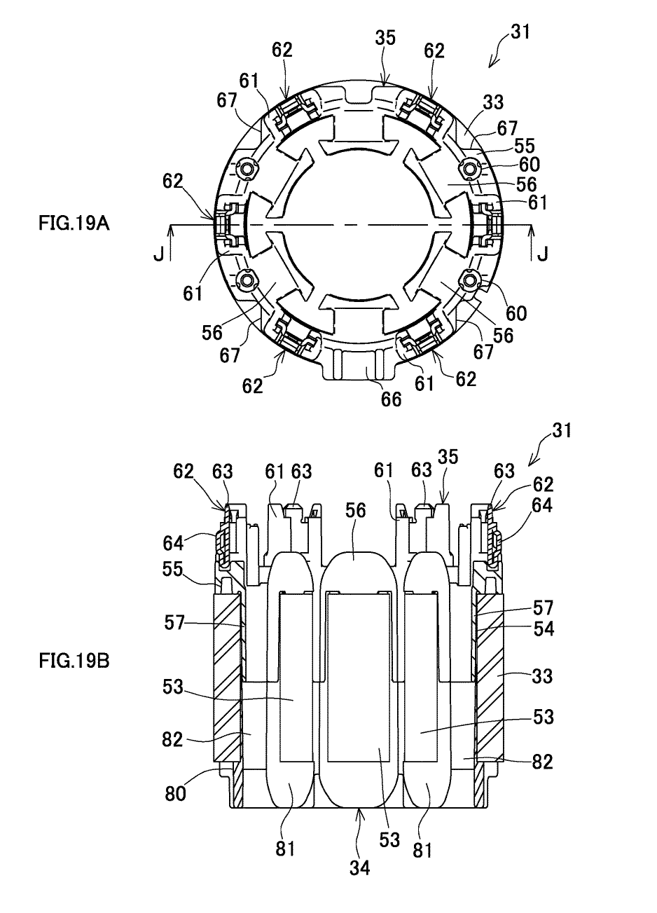

In the above configuration, the front fitting rib of the front insulator is short and the rear fitting rib of the rear insulator is long. Conversely to this, as illustrated in FIG. 18B, the front fitting rib 82 may be configured to be long and the rear fitting rib 57 may be configured to be short. As illustrated in FIG. 19B, both fitting ribs 82 and 57 may be configured to have an identical length to overlap with one another on the intermediate portion of the stator core 33 in the axial direction, and the lengths of the fitting ribs may be alternately changed on the respective insulators. The length of the overlapping part may be increased compared with the above configuration, and the thickness of the fitting rib may be changed on the overlapping part. The number of the fitting ribs may be increased and decreased corresponding to the number of the slots.

Furthermore, for improving an effect of preventing falling-off in assembling, the overlapping end portions may be configured such that one has a protrusion and the other has a depressed portion with which the protrusion engages, or may be configured to have protrusions engaging with one another. In the configuration to engage with one another, the overlap of the fitting ribs is not required, and it is not necessary to dispose the fitting rib on every slot.

Besides, in the brushless motor, the sensor circuit board and the short-circuit member may be disposed conversely back and forth, or the sensor circuit board and the short-circuit member may be integrally formed. However, the short-circuit member may be omitted to employ ordinary delta connection and Y-connection. In this case, the sensor circuit board may be secured to any of the front and rear insulators so as to directly couple the respective end portions of the six coils to the sensor circuit board. At this time, when the longer fitting rib is disposed on the insulator on the sensor circuit board side, an excellent assemblability is provided. In case of not considering the assemblability, a configuration may be employed such that a folded portion (insulation resin for the coil and the stator) is disposed independent of the front and rear insulators so as to include three members.

Not limiting to the brushless AC motor, insofar as the wire-wound type motor, even in a brushless DC motor, a commutator motor with brush, and similar motor, the present disclosure can be employed to ensure the insulation distance. Even the DC motor, when the driving voltage is high, the present disclosure provides an advantage to ensure the insulation distance. Needless to say, the electric power tool is not limited to the circular saw, and the present disclosure is applicable to even other tools such as an impact driver, a driver drill, a hammer drill, a grinder, and similar tool.

Then, while the fitting rib disposed on the insulator is used to ensure the insulation distance in the above configuration, the insulation paper can be used to ensure the insulation distance. The following describes the configuration. However, since the structure of such as the circular saw is similar to the above configuration, like reference numerals designate corresponding or identical components throughout the above-described embodiment and the following modifications, and therefore such elements will not be further elaborated here. A stator having a different structure will be described.

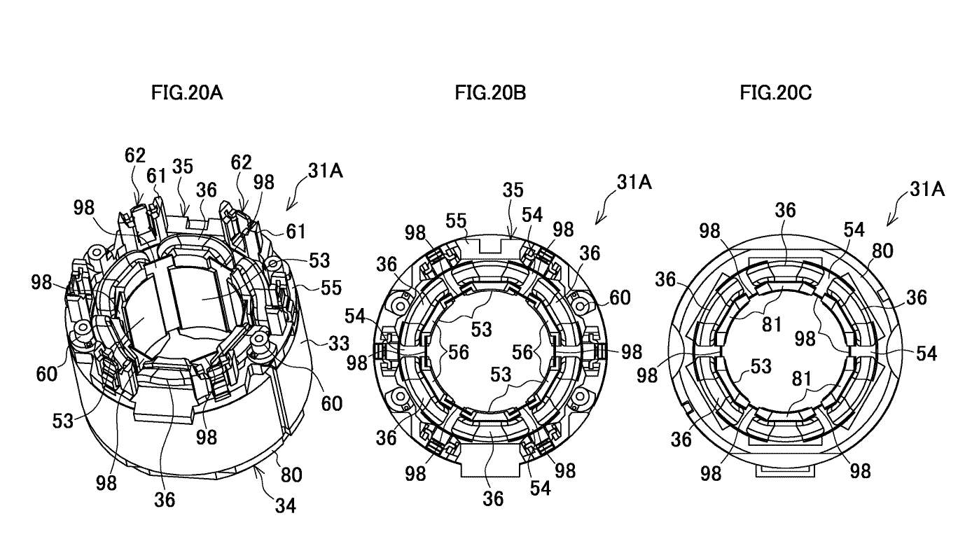

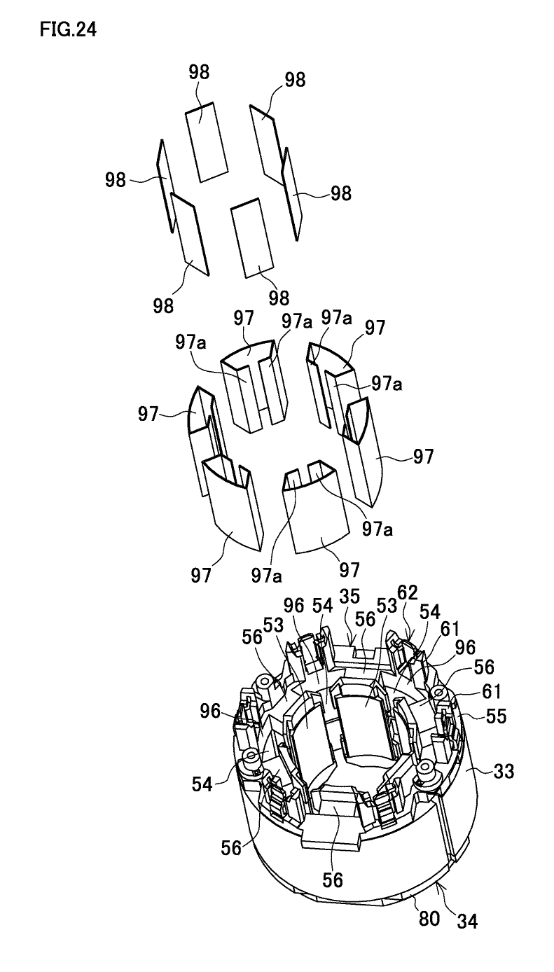

In a stator 31A illustrated in FIG. 20A to FIG. 24, a front fitting rib 95 and a rear fitting rib 96, which are disposed on the ring portions 80 and 55 and the insulation ribs 81 and 56 of the front and rear insulators 34 and 35, extend to the center side of the stator core 33 in the axial direction. However, the front fitting rib 95 and the rear fitting rib 96 do not have length for overlapping with one another, thus being separated in the axial direction. In this embodiment, the slots 54 each include a first insulation paper 97 and a second insulation paper 98.

Similarly to the front and rear fitting ribs 95 and 96, the first insulation papers 97 have a semi-cylindrical shape fitting to the slots 54, with a shape approximately identical to the inner shape of the slot 54 over the inner edges of the insulation ribs 56, 81 and the inner edges of the ring portions 55, 80 adjacent in the circumferential direction. The first insulation papers 97 are each inserted into the slot 54 so as to be disposed across both fitting ribs 95 and 96 on the inner peripheral side of the front and rear fitting ribs 95 and 96.

The second insulation papers 98 are disposed on the center side of the stator core 33 with respect to the first insulation papers 97. The second insulation papers 98 each have a rectangular shape to obstruct between the teeth 53, 53 adjacent in the circumferential direction, and are each held across between the front fitting ribs 95, 95 adjacent in the circumferential direction and between the rear fitting ribs 96, 96 adjacent in the circumferential direction in the identical phase.

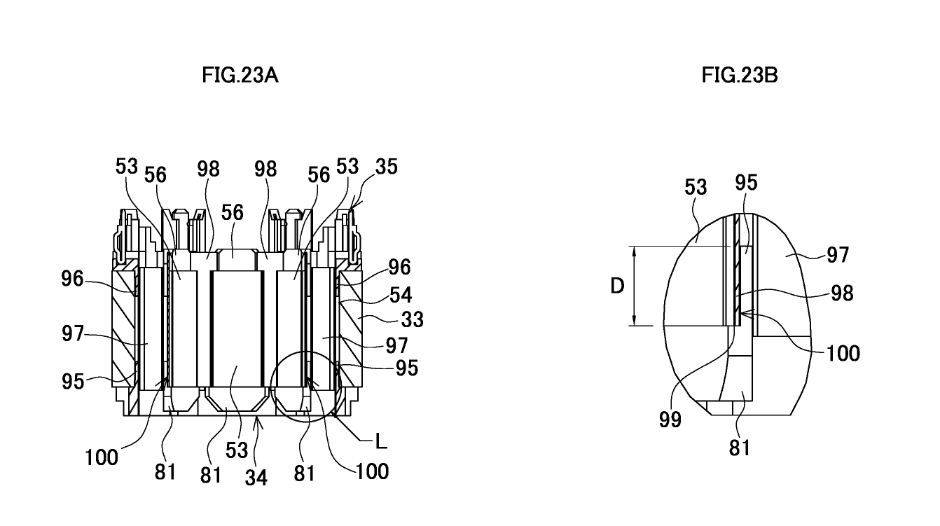

As illustrated in FIG. 23B, the insulation rib 81 on the front side has the rear surface on which a receiving surface 99 is disposed to be locked to the end edges of the teeth 53. The receiving surface 99 extends to the outer peripheral side of the stator core 33 with respect to the teeth 53. Both ends of the front fitting rib 95, positioned on the center side of the stator core 33, include front gaps 100, 100, to which the second insulation papers 98 are insertable, are disposed on the outer peripheral side of the teeth 53. The front gap 100 has the front side obstructed by the receiving surface 99, and opens on the rear side and the teeth 53 sides adjacent in the circumferential direction.

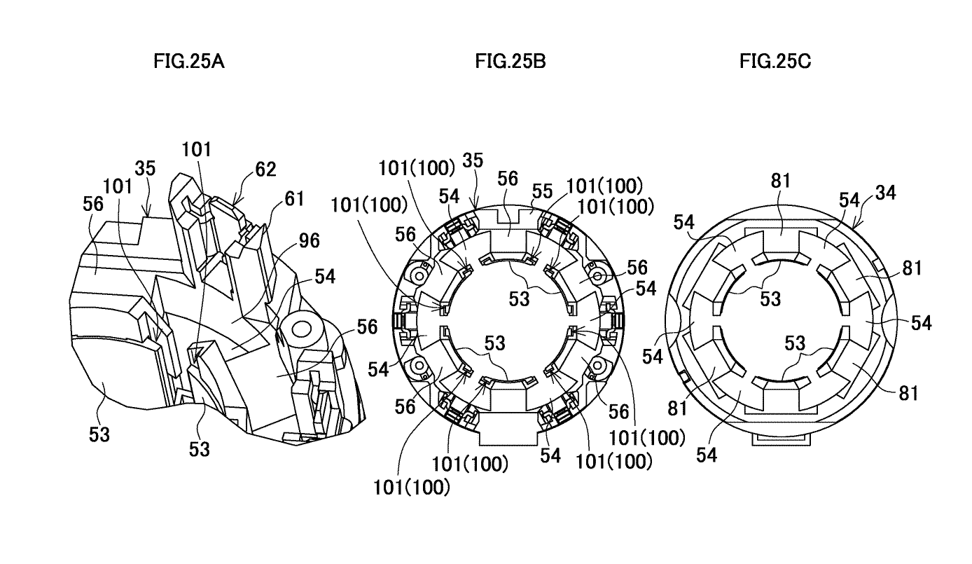

On the other hand, on the rear insulator 35 side, as illustrated in FIGS. 25A to 25C, both ends of the insulation rib 56 on the center side and both ends of the rear fitting rib 96 on the center side include rear gaps 101, 101 to which the second insulation papers 98 are insertable, and are disposed on the outer peripheral sides of the teeth 53. The rear gap 101 axially overlaps with the front gap 100, and opens front to rear and the teeth 53 sides adjacent in the circumferential direction.

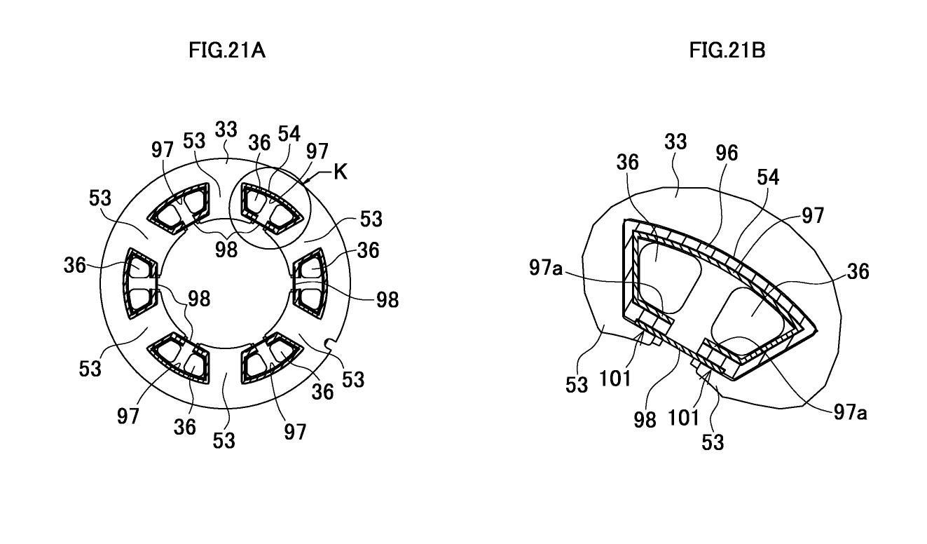

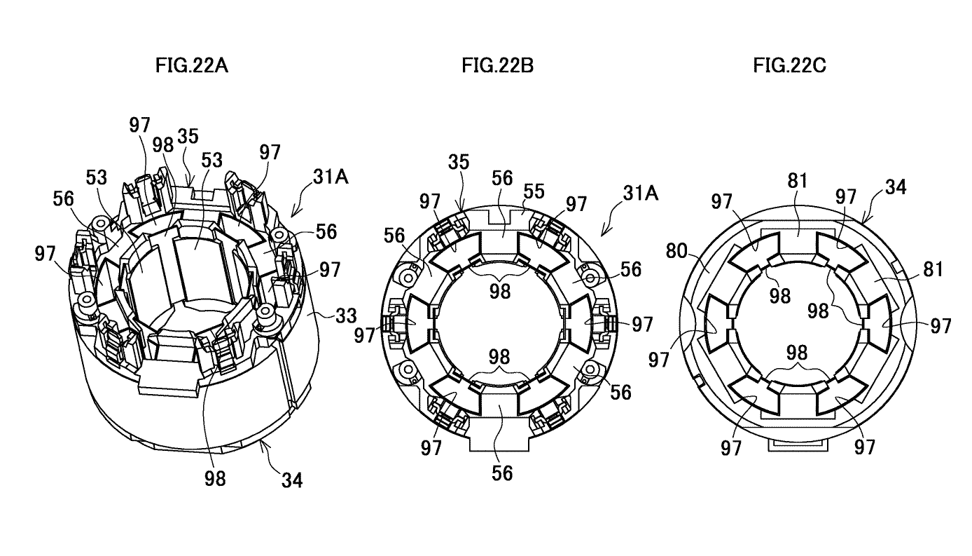

Therefore, on the stator 31A, the front insulator 34 and the rear insulator 35 are inserted into the stator core 33 from the front and the rear respectively until the ring portions 80 and 55 are each brought in contact with the end surfaces of the stator core 33 while the front fitting rib 95 and the rear fitting rib 96 are fitted to the slot 54 in the identical phase. Then, the first insulation papers 97 are each inserted into the slots 54 across the front fitting rib 95 and the rear fitting rib 96. Thus, the inner surfaces of the slots 54 are each covered with the first insulation paper 97, as illustrated in FIG. 21A to FIG. 22C. At this time, both ends 97a, 97a of the first insulation paper 97 on the center side overlap with both ends of the front fitting rib 95 and the rear fitting rib 96 on the center side from inside.

Accordingly, in the stator core 33 where the front and rear insulators 34 and 35 are assembled, the fusing terminals 62 are each inserted into the holding portion 61 of the rear insulator 35, and the coils 36, 36 . . . are wound around the respective teeth 53 in an order in the circumferential direction such that the crossover wire 36a passes between the base portion 63 and the clamping piece 64 of each fusing terminal 62, thus fusing the crossover wire 36a at each fusing terminal 62.

Then, from the rear insulator 35 side, the second insulation papers 98 are each inserted into the inside of the slot 54 such that both ends of the second insulation paper 98 in the lateral direction pass through the rear gaps 101, 101 between the teeth 53, 53 adjacent in the circumferential direction, and the second insulation papers 98 are pushed in until the front ends are inserted into the respective front gaps 100, 100 on the front insulator 34 side. Thus, the front end of the second insulation paper 98 is brought in contact with the receiving surface 99, and the rear end projects between the insulation ribs 56, 56 to obstruct the inside of the respective slots 54, as illustrated in FIGS. 23A and 23B.

In the above state, between the coil 36 passing through the slot 54 and the teeth 53, the first insulation paper 97 overlapping with the front and rear fitting ribs 95 and 96 and the second insulation paper 98 overlapping with the first insulation paper 97 in the radial direction of the stator core 33 are interposed, thus ensuring the insulation distance between the coil 36 and the stator core 33. The overlapping part (part D in FIG. 23B) of the first and second insulation papers 97 and 98 and the front and rear fitting ribs 95 and 96 is also 2.4 mm in the axial direction of the stator 31A, which satisfies the requirements of the above ministerial ordinance and is a sufficient distance for ensuring the insulation.

Thus, even in the above-described circular saw 1, the first insulation paper 97 is interposed between the stator core 33 and the coil 36 in the slot 54, and the second insulation paper 98 is disposed on the center side of the stator core 33 with respect to the coil 36 and overlaps with the first insulation paper 97 in the radial direction of the stator core 33. Therefore, the insulation distance is ensured between the coil 36 and the stator core 33.

Especially, in this embodiment, the front insulator 34 and the rear insulator 35 respectively include the front fitting rib 95 and the rear fitting rib 96 fitting to the slot 54, and the first insulation paper 97 is disposed on the inner sides of the front and rear fitting ribs 95 and 96, and the second insulation paper 98 is disposed on the outer sides of the front and rear fitting ribs 95 and 96 in a state where each overlap in the radial direction. Then, even there is a variation in a stack tolerance of the laminated steel plate in the stator core 33, the overlapping part can absorb the variation, thus ensuring the insulation distance.

The second insulation paper 98 is disposed across the plurality of teeth 53, 53 adjacent in the circumferential direction, and is disposed to protrude from the stator core 33 to the center side, thus surely insulating between the distal ends of the teeth 53 and the coil 36.

While the second insulation paper is formed of one sheet across the teeth in the above configuration, the second insulation papers separated by the teeth adjacent to one another may be each interposed between the distal end of the teeth and the coil.

While the first insulation paper is disposed independent of the second insulation paper in the above configuration, a configuration may be employed such that, for example, both ends of the first insulation paper on the center side are extended to the outside of the fitting rib and folded back to the outer peripheral side of the fitting rib, thus integrally forming the first insulation paper with the second insulation paper.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. An electric power tool configured to drive a tool bit, comprising:
a motor that includes:
a stator including a cylindrical stator core that includes an inner peripheral side with a slot, a first insulator and a second insulator installed on respective both end surfaces of the stator core, and a coil wound around the slot of the stator core via the first insulator and the second insulator; and
a rotor rotatable with respect to the stator, the rotor including a rotor core and a rotation shaft, wherein
the first insulator overlaps with the second insulator in the slot in an axial direction of the stator core.

2. The electric power tool according to claim 1, wherein
the first insulator and the second insulator each include a fitting rib configured to fit to the slot, and end portions of the fitting ribs overlap with one another.

3. The electric power tool according to claim 2, wherein
one of the fitting ribs is formed in a tapered shape toward the other fitting rib side, and the one fitting rib has an end portion that overlaps with an end portion of the other fitting rib from inside.

4. The electric power tool according to claim 2, wherein
the fitting rib on the second insulator side is formed longer than the fitting rib on the first insulator side in the axial direction of the stator core.

5. The electric power tool according to claim 4, wherein
the fitting rib of the second insulator has an outer peripheral base portion that includes a groove whose bottom portion has a cross-sectional shape in a semicircular shape.

6. The electric power tool according to claim 4, wherein
the fitting rib on the second insulator side has a semi-cylindrical shape that opens an inner peripheral side corresponding to an opening side of the slot, and both edges on the inner peripheral side each include folded portions so as to be folded back to an outer peripheral side and subsequently extended to a center side.

7. An electric power tool configured to drive a tool bit, comprising:
a motor that includes:
a stator including a cylindrical stator core that includes an inner peripheral side with a slot, a first insulator and a second insulator installed on respective both end surfaces of the stator core, and a coil wound around the slot of the stator core via the first insulator and the second insulator; and
a rotor rotatable with respect to the stator, the rotor including a rotor core and a rotation shaft, wherein
the first insulator and the second insulator engage with one another to be secured to the stator core.

8. The electric power tool according to claim 7, wherein
the first insulator and the second insulator each include a fitting rib configured to fit to the slot, and end portions of the fitting ribs engage with one another.

9. The electric power tool according to claim 8, wherein
the end portions of the fitting ribs engage with one another by inserting one of the fitting ribs into a gap between the other fitting rib and an inner surface of the slot.

10. An electric power tool configured to drive a tool bit, comprising:
a motor that includes:
a stator including a cylindrical stator core and an insulator, the stator core including an inner peripheral side with a slot, the insulator including a fitting portion disposed to protrude on a ring portion installed on an end surface of the stator core, the fitting portion fitting to the slot; and
a rotor rotatable with respect to the stator, the rotor including a rotor core and a rotation shaft, wherein
a groove is depressed along an outer periphery of the protruding part of the fitting portion on the ring portion.

11. The electric power tool according to claim 10, wherein
the groove has a bottom portion whose lateral cross-sectional shape is a semicircular shape.

12. An electric power tool configured to drive a tool bit, comprising:
a motor that includes:
a stator including a cylindrical stator core that includes an inner peripheral side with a slot, a first insulator and a second insulator installed on respective both end surfaces of the stator core, and a coil wound around the slot of the stator core via the first insulator and the second insulator; and
a rotor rotatable with respect to the stator, the rotor including a rotor core and a rotation shaft, wherein
a first insulation paper is interposed between the stator core and the coil in the slot, and a second insulation paper is disposed integrally with or independent of the first insulation paper on a center side of the stator core with respect to the coil, the second insulation paper overlaps with the first insulation paper in a radial direction of the stator core.

13. The electric power tool according to claim 12, wherein
the first insulator and the second insulator each include a fitting rib configured to fit to the slot, and are disposed in a state where the first insulation paper and the second insulation paper respectively overlap with an inner side of the fitting rib and an outer side of the fitting rib in the radial direction.

14. The electric power tool according to claim 13, wherein
the second insulation paper is disposed across a plurality of teeth adjacent in the circumferential direction, the teeth are disposed to protrude from the stator core to the center side.

15. The electric power tool according to claim 14, wherein
a gap is disposed between the fitting rib and the tooth such that the second insulation paper is inserted into the gap.

16. The electric power tool according to claim 12, wherein
the first insulation paper has a semi-cylindrical shape configured to fit to the slot with a shape approximately identical to an inner shape of the slot.
